(19) United States
(12) Patent Application Publication
(10) Pub. No.: US 2014/0087761 A1
(43) Pub. Date: Mar. 27, 2014

(54) PERSONALIZED PROXIMITY COMMUNICATION

(71) Applicants: Lonny Baskin, Tsur Hadassah (IL); Ariel Malamud, Jerusalem (IL)

(72) Inventors: Lonny Baskin, Tsur Hadassah (IL); Ariel Malamud, Jerusalem (IL)

(21) Appl. No.: 13/627,135

(22) Filed: Sep. 26, 2012

(51) Int. Cl. H04W 4/02

(52) U.S. Cl. CPC H04W 4/021
USPC 455/456.3

(57) ABSTRACT

Described herein are technologies related to personalized communication with a user who is physically located in a designated area for that communication. More particularly, the technology describes detection and identification of a wireless device within the designated area of communication, searching for a corresponding dataset for the identified wireless device, and generating the personalized communication to the user. This Abstract is submitted with the understanding that it will not be used to interpret or limit the scope or meaning of the claims.

### BACKGROUND

Current technologies have created new advertising channels to promote products, services, and the like. For example, a digital sign is a form of electronic display that may be deployed or utilized for different purposes such as, but not limited to, showing advertisements (e.g., latest or discounted products of a retail store), displaying public information (e.g., news, weather, travel information, etc.), and other multimedia content that may be displayed on screens. For digital signage purposes, the multimedia content may refer to anything designed or displayed on the screens such as text, images, animations, video, audio, and interactivity.

The digital signage typically provides the multimedia content when attached to one or more computers or networks. In other words, advances in the one or more computer or networks such as in hardware and/or software components may correspondingly affect the digital signage to provide greater flexibility and/or advantage to general purpose of the digital signage. For example, management of the digital signage to provide greater flexibility in a commercial environment may benefit customers, clients, passengers, patients, sellers, business operators, controller, and the like.

### BRIEF DESCRIPTION OF THE DRAWINGS

FIG. 1 illustrates a scenario to include opting in by a user to avail of associated benefits in a personalized proximity communication.

FIG. 2 illustrates an example personalized proximity communication scenario utilizing a wireless fidelity (Wi-Fi) based wireless access point (WAP).

FIG. 3 illustrates an example personalized proximity communication scenario utilizing video analytics.

FIG. 4 illustrates an example personalized proximity communication scenario utilizing a cellular signal based personalized proximity communication (PCC) zone.

FIG. 5 illustrates an example process for personalized and/or interactive digital signage.

FIG. 6 illustrates an example process for personalized and/or interactive digital signage at user side.

FIG. 7 illustrates an example computing device to implement personalized proximity communication.

FIG. 8 illustrates an example device to implement personalized proximity communication.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Described herein is a technology for personalized communication with a user who is physically located in a designated area for that communication. The personalized communication may be, for example, via digital signage, text message, e-mail, public address (PA) system, or other such messaging. The content of the personalized communication may be, for example, an advertisement, commercial message, directions, announcement, or the like. Prior to or upon entering the designated area for personalized communication, the user may choose to participate (i.e., “opt-in”) or not participate (“opt-out”) with a program for such a personalized communication. For “opt-in” participation, the user may receive the content of the personalized communication that corresponds to his “opt-in” user profile. For “opt-out” participation, the user may receive the content of the personalized communication that corresponds to a broad profile of users. For example, the broad profile of users may utilize foot traffic patterns and/or dwell time of users within the designated area of communication.

More specifically, the disclosed technologies include detection and identification of a wireless device through a radio signal within a personalized proximity communication (PPC) zone. For example, the radio signal may include a wireless fidelity (Wi-Fi) signal, a Bluetooth™ signal, cellular signal, a near field communication (NFC) signal, radio frequency (RF) signal, etc. that may define specific range for the PPC zone. In this example, the specific range may include few millimeter for the NFC, tens of meters for the Wi-Fi or Bluetooth™ signal, or tens of miles for the cellular signal.

In an implementation, the detection and/or identification of the wireless device may utilize a transmitted media access control (MAC) address of the wireless device in case of Wi-Fi, Bluetooth™, or cellular signal based PCC zone, or it may utilize RF identification (RFID) of the wireless device in case of NFC based PCC zone. Additionally, the detection and/or identification of the wireless device may utilize another form such as when the user opts-in through the Internet when joining a loyalty club organization. In this implementation, the MAC address or RFID may correspond to a dataset that includes customer data of the user. For example, the customer data may include limited degree of participation by the user to get associated benefits from the personalized proximity communication. In this example, the associated benefits may include communicating a corresponding limited multimedia content via the digital signage, text message, e-mail, public address (PA) system, or other such messaging.

### Example Scenarios

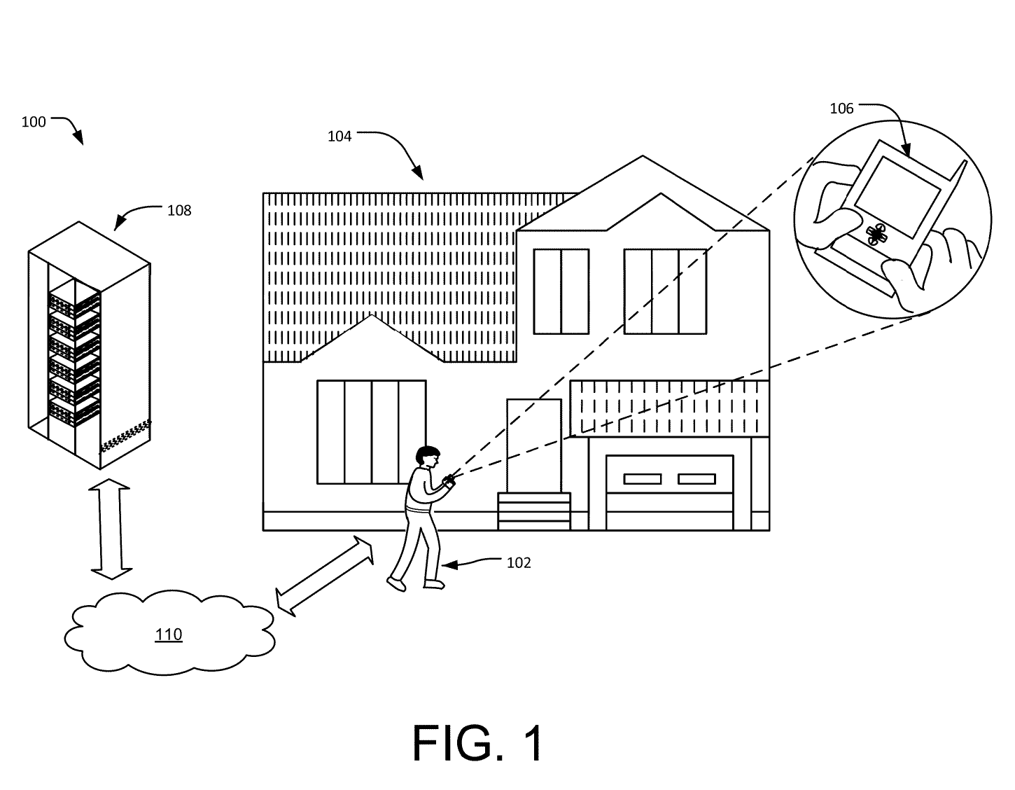

FIG. 1 illustrates an example scenario 100 that includes opting in by a user 102 to avail of associated benefits in a personalized communication relationship. Scenario 100 includes example implementation of the technology described herein.

As depicted, the scenario 100 includes the user 102 leaving his home 104 and using a wireless device 106 to connect to a database 108 through a network 110. For example, the user 102 plans to go to a clothing retail store (not shown) and subscribes (i.e., opts-in) to a personalized communication program (not shown) of the clothing retail store that implements its services using personalized communication. In this example, the personalized communication includes an ability of the clothing retail store to communicate its services or other information to the user 102 according to a certain dataset (not shown) that defines the limit of what the user 102 may want to receive from the personalized communication program. The personalized communication program may include software and/or hardware components to implement detecting and/or identifying of the wireless device 106, searching of the database 108 for a corresponding dataset of the identified wireless device 106, and generating the personalized communication to the user 102 using the found dataset.

The dataset may include personal or physical information that the user 102 enters when subscribing to the personalized communication program. For example, the user 102 enters the dataset that includes a particular brand, make, and model of the latest clothing designs that the user 102 may want to receive when visiting the clothing retail store. In this example, the dataset of the user 102 limits the personalized communication that may follow between the clothing retail store and the user 102. In other words, in this example, the user 102 may receive the personalized communication that is limited by the particular brand, make, and model of the latest clothing designs from the clothing retail store.

Examples of the wireless device 106 include a phone, cell phone, smartphone, tablet computer, personal digital assistant (PDA), portable computer, laptop, netbook, digital camera, and digital media player. The wireless device 106 may include a unique MAC address (not shown) for each unit and the unique MAC address may provide particular identification for each of the wireless device 106 during wireless communication that utilizes a Wi-Fi signal, Bluetooth™ signal, or a cellular signal. In the case of near field communication, the wireless device 106 utilizes its particular unique RFID during wireless communication.

With continuing reference to FIG. 1, the user 102 may opt-in later to the personalized communication program upon arriving at the clothing retail store. For example, the user 102 may manually fill up or enter the dataset in an application form for the personalized communication program at the clothing retail store. In this example, the clothing retail store may initiate the entering and storing of the dataset in the database 108 by utilizing their own computing device (not shown). In another example, the user 102 may opt-in at any time or any place such as when joining loyalty club on the Internet.

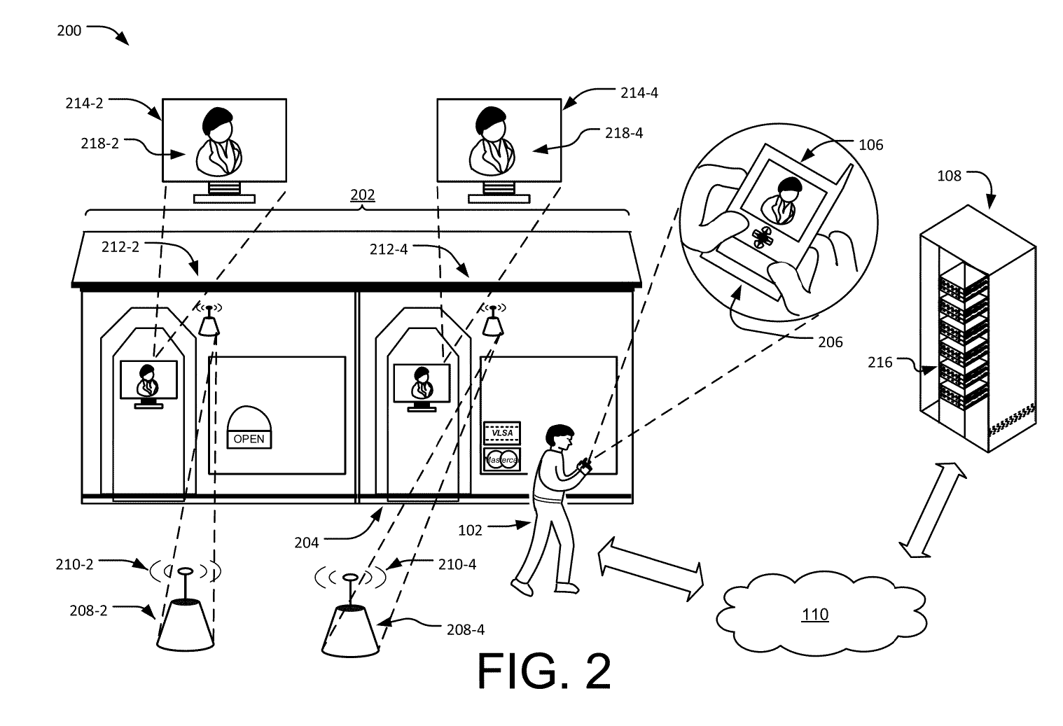

The database 108 may receive the subscription and the dataset from the user 102 through the network 110. To this end, the database 108 may provide organized collection of the dataset to support the clothing retail store in generating and/or communicating product information or updates to the user 102. As further discussed in FIG. 2, a detection and identification of the wireless device 106 when the user 102 enters a designated area of communication at the clothing retail store triggers determination and finding of the dataset at the database 108.

FIG. 2 illustrates another example scenario 200 of an implementation of technology disclosed herein. The scenario 200 includes personalized communication utilizing a wireless fidelity (Wi-Fi) based personalized proximity communication.

As depicted, the scenario 200 includes a commercial center 202, a clothing retail store 204, user 102, wireless device 106, MAC address 206, a Wi-Fi based wireless access point (WAP) 208, WAP signals 210, PCC zones 212, digital signage 214, dataset 216, and the database 108. Furthermore, the digital signage 214 shows a picture 218 of the user 102 during the personalized communication.

In this scenario 200, the user 102 with the wireless device 106 on hand visits the commercial center 202 and passes through the clothing retail store 204. For example, the clothing retail store 204 is one of the retail stores in the commercial center 202 for which the user 102 is a subscriber (i.e., has opted in) to their product information and updates. As depicted in scenario 100, the user 102 may opt-in upon arriving at the clothing retail store 204 rather than opting-in while the user 102 is about to leave his home 104.

Upon arriving at the premises or designated area of communication (i.e., PCC zone 212) in the clothing retail store 204, the wireless device 106 establishes wireless connection or communication with the Wi-Fi based WAP 208-2. For example, the Wi-Fi based WAP 208-2 generates the WAP signals 210-2 for its wireless local area network (WLAN) and the wireless device 106 communicates its MAC address 206 through the WAP signals 210 during exchanging of data to establish the wireless connection. In this example, the range of transmission of the WAP signals 210-2 may define extent of the PPC zone 212-2. As shown in FIG. 2, another Wi-Fi based WAP 208-4 may generate WAP signals 210-4 at another location in the commercial center 202. In other words, the PPC zone 212 may include a larger coverage area such as when the PPC zone 212 utilizes multiple number of Wi-Fi based WAP 208, or the PPC zone 212 may include a smaller area such as when the PPC zone 212 utilizes the NFC or Bluetooth™ signal.

Upon establishing of the wireless connection, the identification of the MAC address 206 through the Wi-Fi based WAP 208 may allow the personalized communication program to search and determine the dataset 216 that corresponds to the wireless device 106. The determination of the dataset 216 based on the MAC address 206 may go back to the time of “opting in” or subscription by the user 102 when the user 102 registers his wireless device 106 that may be identified through the MAC address 206. In the case where the user 102 “opts-in” upon entering the clothing retail store 204, the entering of the dataset 216 to the database 108 by the clothing retail store 204 may create the identification for the wireless device 106.

The dataset 216 may include data structure to define user profile of the user 102. For example, in the scenario 200 that depicts the retail store 204, the user profile may include degree of participation for user's privacy control. Furthermore, the user profile may include age, gender, clothing sizes for different clothing styles, loyalty discount member identification, names of organizations and/or clubs for which the user 102 is a member, and the like that may provide exact customer data to display at the digital signage 214 and/or the wireless device 106. The exact customer data may include the personalized message that corresponds to the user profile of the wireless device 106.

The user 102 defines the extent that his information is used for personalized communication. The user may fully participate or only partially participate. This limited participation in the personalized communication is called the degree of participation for user's privacy control. For example, if the user 102 opted-in to the personalized communication program in order to avail of the information on latest clothing designs such as current clothing products with fifty percent discounts only, then the personalized communication may communicate to the wireless device 106 and/or the digital signage 214 those clothing products with fifty percent discounts on it. In this example, the depicted digital signage's 214-2 and 214-4 may display the user 102 wearing the clothing product with fifty percent discount as shown in the picture 218.

The above example with regard to the user profile in the dataset 216 is only for purposes of illustration; however, different services such as in an airline industry, riding a commercial train, going to rental cars, entering a restaurant, etc. may require a different set of user profile in the dataset 216. For example, in riding the commercial train, the dataset 216 may include the user profile that indicates a section of the commercial train where the user 102 will be sitting. In this example, the user profile for the user 102 may indicate whether the user 102 is a senior citizen or needs special assistance when riding the commercial train.

With continuing reference to FIG. 2, the multiple PPC zones 212 includes additional Wi-Fi based WAP 208-4 to serve the retail store 204 albeit at a different location in the commercial center 202. In this example, the detection and identification of the wireless device 106 in the other PPC zone 212-4 may similarly implement the personalized communication as described above. Furthermore, multiple digital signages 214 at different locations in the commercial center 202 may produce multiple displays for the personalized communication between the retail store 204 and the user 102.

In another implementation, the Wi-Fi based WAP 208 may use the Bluetooth™ signal to behave as Bluetooth™ signal WAP. The Bluetooth™ signal WAP may use the same radio frequencies as the Wi-Fi based WAP 208 (e.g., 2.4 GHz) but with a lower power, resulting in lower bit rates and range from Bluetooth™ signal WAP base station. For example, the PPC zone 212 for Bluetooth™ signal wireless personal area network (WPAN) is smaller in coverage than the PPC zone 212 for the Wi-Fi based WAP 208 due to higher power transmission for generating the WAP signals 210. In this implementation, the process of availing associated benefits from the personalized communication program in scenario 200 may similarly apply.

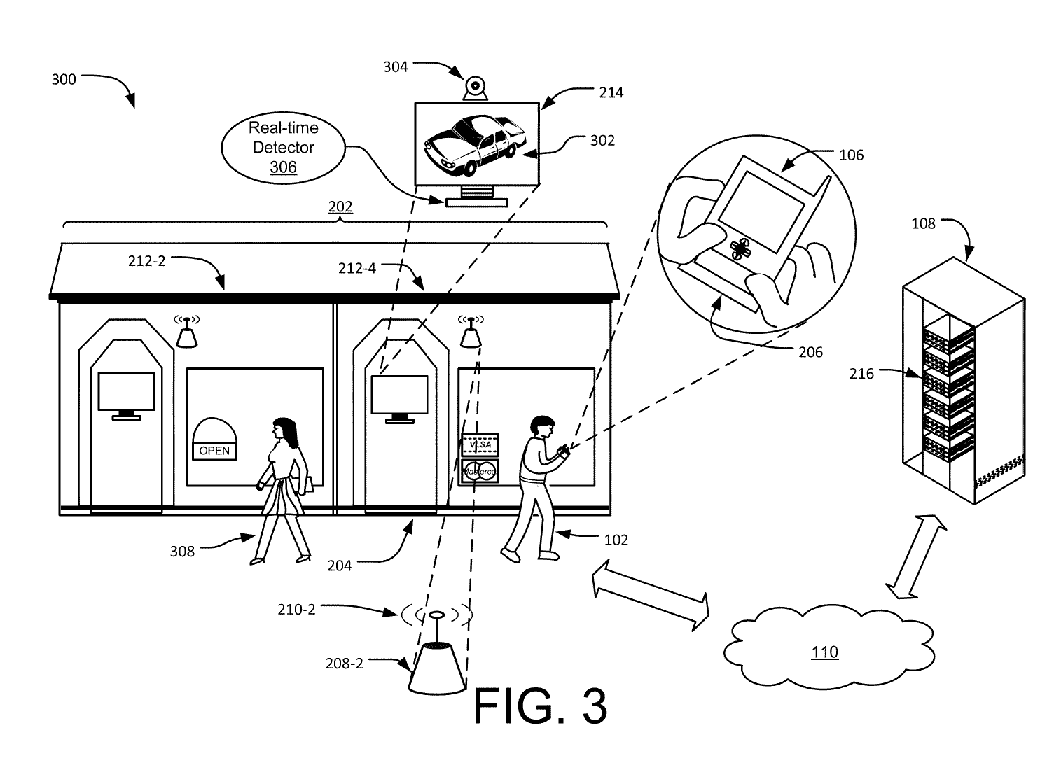

FIG. 3 illustrates another example scenario 300 of an implementation of technology disclosed herein. The scenario 300 includes the digital signage 214 acting as a passive device or an active device. When acting as passive device, digital signage 214 merely displays at screen 302 the personalized message from the personalized communication program. When acting as active device, the digital signage 214 may additionally be equipped with, but not limited to, a camera 304 and real-time detector 306 to analyze video of one or more passersby (e.g., user 102 and user 308) to generate the personalized message.

The above scenarios 100 and 200 illustrate the digital signage 214 at passive mode. In other words, the digital signage 214 does not perform detecting of the one or more passerby, or initiate personalized communication with the wireless device 106. For example, the digital signage 214 displays at the screen 302 whatever personalized message the personalized communication program may generate. In this example, the digital signage 214 merely acts as electronic display.

With continuing reference to FIG. 3, the digital signage 214 utilizes the camera 304 and the real-time detector 306 to implement video analytics. The video analytics may include capability of the digital signage 214 using the camera 304 and the real-time detector 306 (e.g., Intel audience impression metric (AIM) Suite software) to analyze automatically video of passersby or observers such as the users 102 and 308. For example, the camera 304 detects physical features (e.g., height, weight, gender, etc.), race, amount of foot traffic, or the like of the passersby or observers such as the users 102 and 308 who are passing by the clothing retail store 204. In this example, the real-time detector 306 using video analytics software may generate personalized message that corresponds to these detections. More specific example may include detection of majority of the passersby or observers to be teenagers. In this example, the real-time detector 306 may run the video analytics software to find current advertisement that is extremely popular to this age bracket (i.e., teenagers). The found advertisement may include latest picture of a sports car and the real-time detector 306 may initiate the displaying of the found advertisement through the screen 302 to attract the attention of the teenagers to enter the clothing retail store 204. In this implementation, the user 308 may not be a subscriber (i.e., opted-out) to personalized communication program of the clothing retail store 204. However, the video analytics may still utilize presence of the user 308 when detecting the amount of foot traffic, dwell time or amount that the user 308 is staying within the vicinity of the clothing retail store 204, and the like for retail usages.

In another implementation, the video analytics may combine with the detection of the wireless device 106 through the Wi-Fi based WAP 208 within the PPC zone 212. For example, the user 102 opts-in to the personalized message that the video analytics in the clothing retail store 204 may generate. In this example, the detection of the wireless device 106 within the PPC zone 212 may allow the sending of the advertisement (e.g., picture of sports car) to the wireless device 106. In another implementation, the video analytics may utilize the user profile of the user 102 in generating exact customer data for the personalized message. For example, the real-time detector 306 may utilize the dataset 216 of the wireless device 216 in detecting the amount of traffic that passes through the clothing retail store 204. In another example, the real-time detector 306 may utilize a photo of the user 102 upon opting-in or taken when the user 102 enters the store. In this example, the personalized message on the screen 302 may show the user 102 with a clothing product (e.g., suit and tie) that corresponds to his user profile for a fully personalized shopping experience.

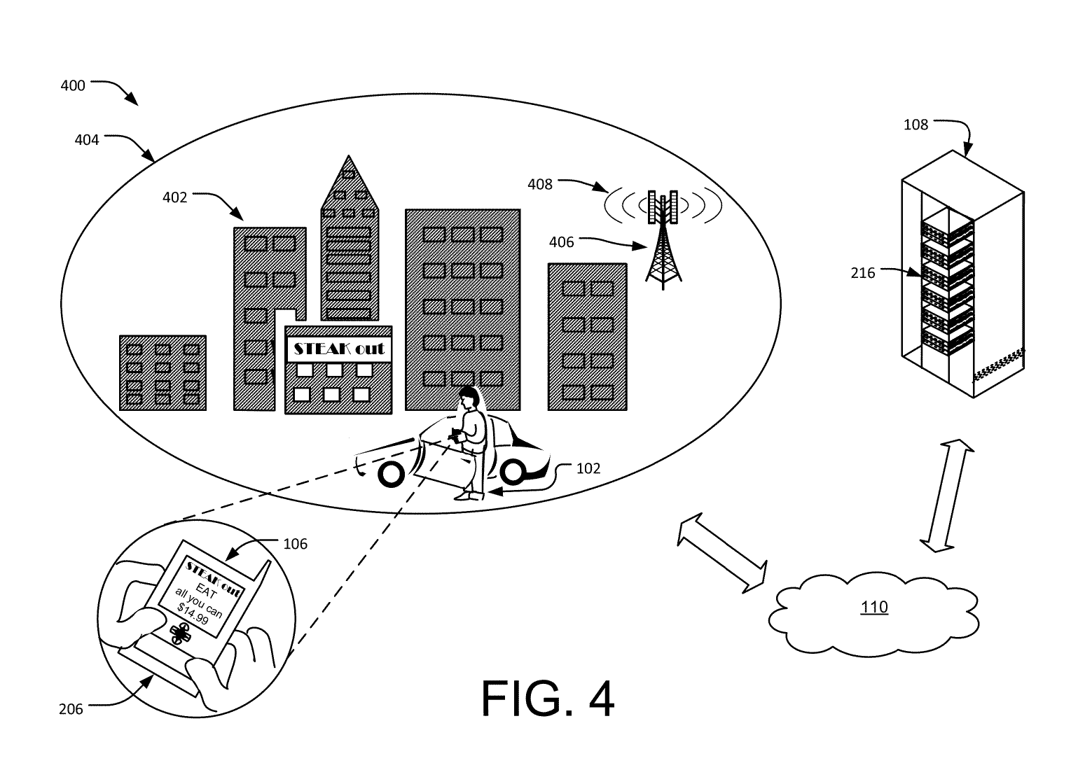

FIG. 4 illustrates another example scenario 400 of an implementation of technology disclosed herein. The scenario 400 includes personalized communication utilizing a cellular signal based personalized proximity communication.

As depicted, the scenario 400 includes a business district 402, a PCC zone 404, a cellular tower 406, cellular signals 408, wireless device 106 and the database 108.

In an implementation, the user 102 of the wireless device 106 may opt-in to advertisements, services, information, etc. that may be available when the user 102 drives through or enters a particular PCC zone 404 that includes the business district 402. In this implementation, the range of the cellular signals 408 may define the extent of the PCC zone 404. In another implementation, deploying multiple Wi-Fi based WAP 208 within the business district 402 may define the extent of the PCC zone 404.

Upon entering the PCC zone 404, the wireless device 106 of the user 102 establishes wireless connection with the cellular tower 406 and communicates its MAC address 206 during the data exchange. Similar to above discussions in scenarios 100 and 200, the identification of the MAC address 206 may trigger the determination of the dataset 216 in order to generate the corresponding personalized message. For example, if the user 102 opts-in to advertisement of shopping malls within the PCC zone 404, then the user 102 may receive through the wireless device 106 the names and locations of the nearest shopping malls upon entry to the PCC zone 404.

### Example Method

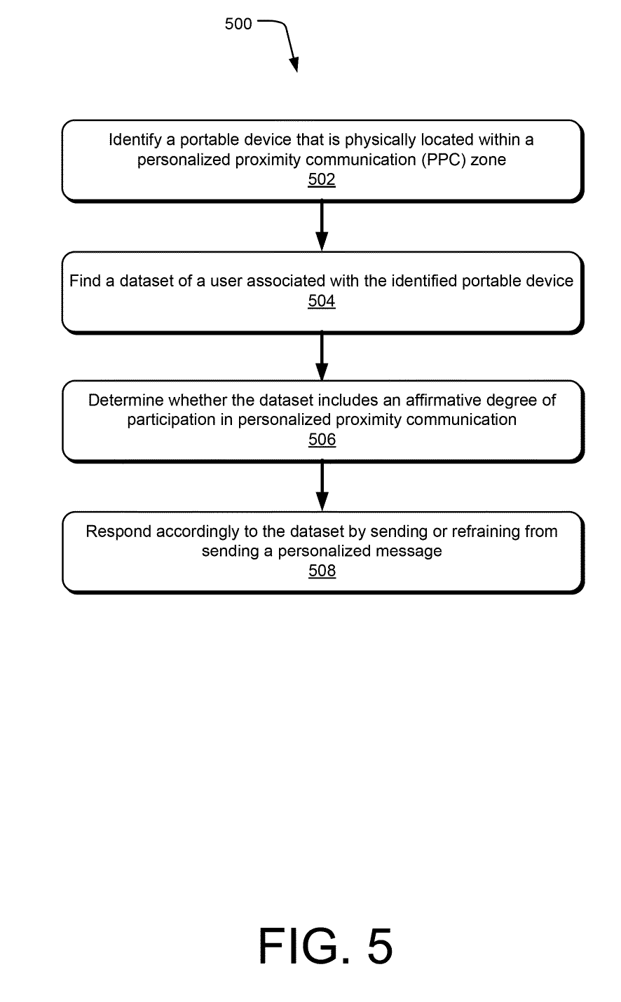

FIG. 5 shows an example process chart 500 process for personalized proximity communication. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 502, a Wi-Fi based WAP identifies a wireless device that is physically located within one or more designated PPC zones. For example, a user (e.g., user 102) using the wireless device (e.g., wireless device 106) may enter the designated one or more PPC zones (e.g., PPC zone 212) and establishes wireless connection/communication with the Wi-Fi based WAP (e.g., Wi-Fi based WAP 208). In this example, the establishing of the wireless connection includes exchanging of data that includes communicating of a MAC address (e.g., MAC address 208) of the wireless device 106 to the Wi-Fi based WAP 208.

In another example, Bluetooth™ signal based WAP, cellular signal based PPC zone (e.g., PPC zone 404), or NFC signal based communication may replace the Wi-Fi based WAP 208 in identifying the wireless device 106. For example, the Bluetooth™ feature or the NFC feature of the wireless device 106 transmits the MAC address 208 and/or the RFID, respectively, during exchanging of data when establishing the wireless connection. In this example, any one or all of these technologies (i.e., Wi-Fi feature, Bluetooth™ feature, etc.) may provide the identification for the wireless device 106.

Although the described techniques for identifying the wireless device 104 were in the context of using the Wi-Fi based WAP 208, Bluetooth™ signal based WAP, cellular signal based PPC zone, or the NFC signal based communication, other communication technologies that employ radio signal may be used.

At block 504, a computing system running a personalized communication program finds a dataset of the user associated with the identified wireless device. For example, the identification of the MAC address 208 may trigger the personalized communication program to search for the dataset (e.g., dataset 216) that corresponds with the identified wireless device 106.

At block 506, the computing system running the personalized communication program determines whether the found dataset includes an affirmative indication of participation in personalized proximity communication. For example, the dataset 216 may include user profile such as personal and physical information of the user 102. In this example, the user profile 212 may define the extent for which the personalized communication utilizes his information. For example, the user 102 may fully participate or only partially participate in the personalized communication.

At block 508, the computing system running the personalized communication program responds by sending personalized message according to the determination of degree of participation by the user 102 in the personalized proximity communication. For example, the personalized communication program may respond according to the degree of participation for privacy control by the user 102. In this example, a digital signage (e.g., digital signage 214) or the wireless device 106 may display the response or the personalized message.

The response may include a communication with the user 102 of the identified wireless device 106 in the event that the found dataset 216 includes an affirmative indication of degree of participation, wherein the communicating occurs within the one or more designated PPC zones 212 in which the identified wireless device 106 is located. The response may include generation of a personalized message to the user 102. The personalized message includes or is based upon the user's personalized data in the found dataset.

With that personalized message, the response may further include a selection of one or more digital signs that are observable from the one or more designated PPC zones 212 in which the identified wireless device 106 is located and then a display of the personalized message on such signs.

Alternatively or additionally, the response may include sending the generated personalized message to the user 102 via the identified wireless device 106.

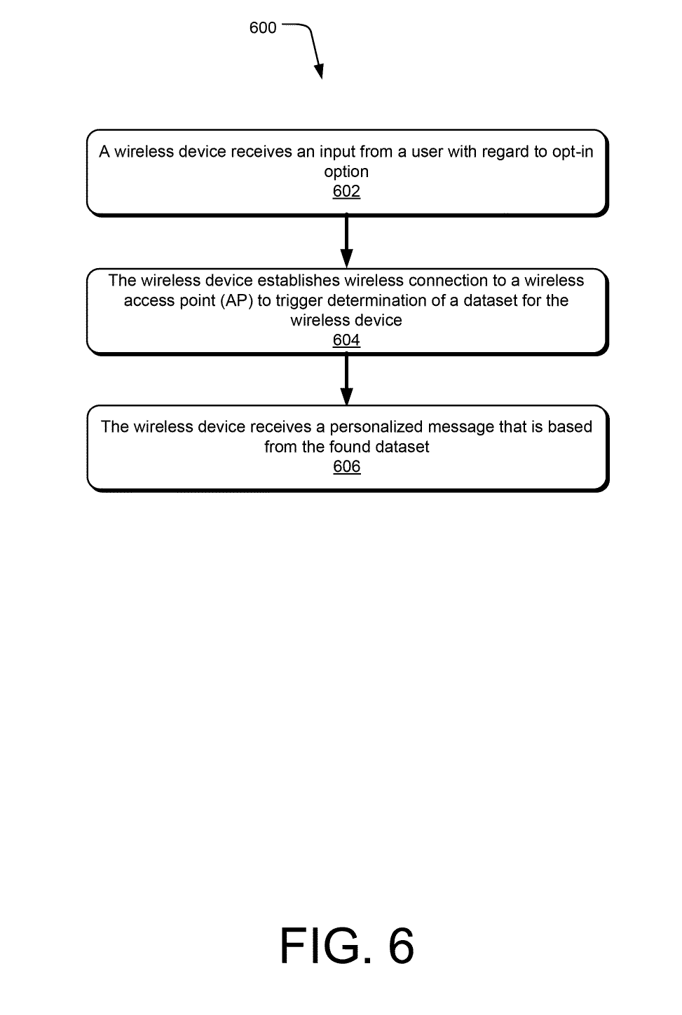

FIG. 6 shows an example process chart 600 process for personalized proximity communication at user side. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 602, the wireless device receives an input from the user who opts-in to the personalized communication program. For example, the user 102 opts-in at any time or in any place to the personalized communication program. In another example, the user 102 opts-in upon enrolling to services (e.g., loyalty club) that utilizes the personalized communication program.

At block 604, the wireless device establishes a wireless connection to the WAP. For example, within the one or more PPC zones 212, the wireless device 106 establishes wireless connection with the Wi-Fi based WAP 208. The establishing of wireless connection may allow the personalized communication program to identify the wireless device 106 through its MAC address 206. The identification of the wireless device 106 may allow the personalized communication program to find the corresponding dataset 216 for the user 102 and generates the personalized message as a response to the found dataset 216.

At block 606, the wireless device receives the personalized message through the wireless device. For example, the wireless device 106 displays the personalized message that corresponds to the user profile of the user 102. In another example, the digital signage 214 also displays concurrently the personalized message to the user 102.

### Example Computing Device

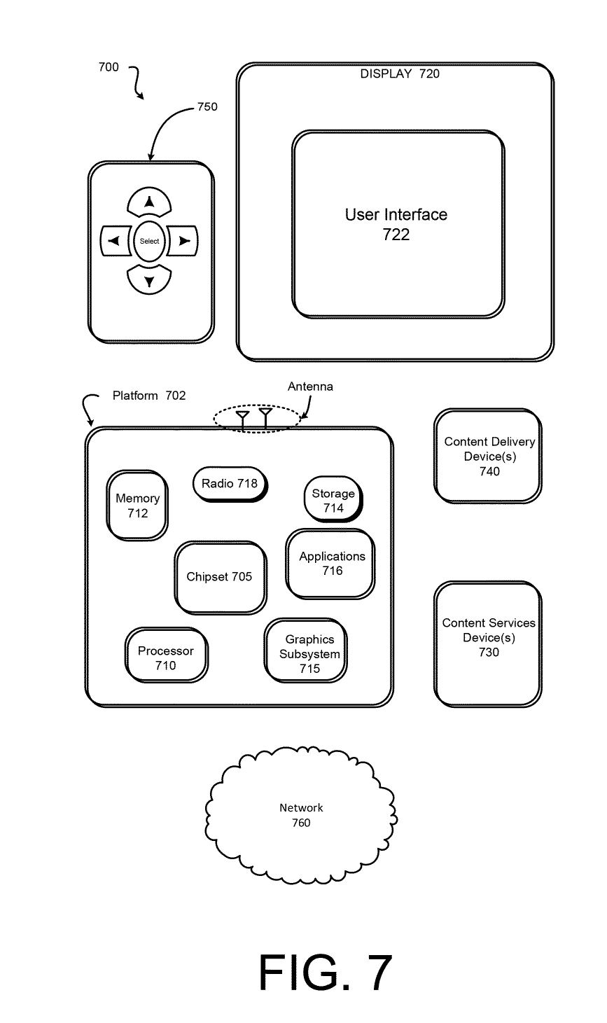

FIG. 7 illustrates an example system 700 in accordance with the present disclosure. For example, the real-time detector 306 utilizes the example system 700. In various implementations, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 700 includes a platform 702 coupled to a display 720. Platform 702 may receive content from a content device such as content services device(s) 730 or content delivery device(s) 740 or other similar content sources. A navigation controller 750 including one or more navigation features may be used to interact with, for example, platform 702 and/or display 720. Each of these components is described in greater detail below.

In various implementations, platform 702 may include any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 710 may be dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 714 may include technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, Display Port, wireless HDMI, and/or wireless HD compliant techniques. Graphics subsystem 715 may be integrated into processor 710 or chipset 705. In some implementations, graphics subsystem 715 may be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general-purpose processor, including a multi-core processor. In further embodiments, the functions may be implemented in a consumer electronics device.

Radio 718 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In various implementations, display 720 may include any television type monitor or display. Display 720 may include, for example, a computer display screen, touch screen display, video monitor, television-like device, and/or a television. Display 720 may be digital and/or analog. In various implementations, display 720 may be a holographic display. In addition, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In various implementations, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In various implementations, content services device(s) 730 may include a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be replicated on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but may be integrated into platform 702 and/or display 720. The present disclosure, however, is not limited to the elements or in the context shown or described herein.

In various implementations, drivers (not shown) may include technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 even when the platform is turned “off.” In addition, chipset 705 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the present disclosure.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

As described above, system 700 may be embodied in varying physical styles or form factors. FIG. 7 illustrates implementations of a small form factor device 700 in which system 700 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

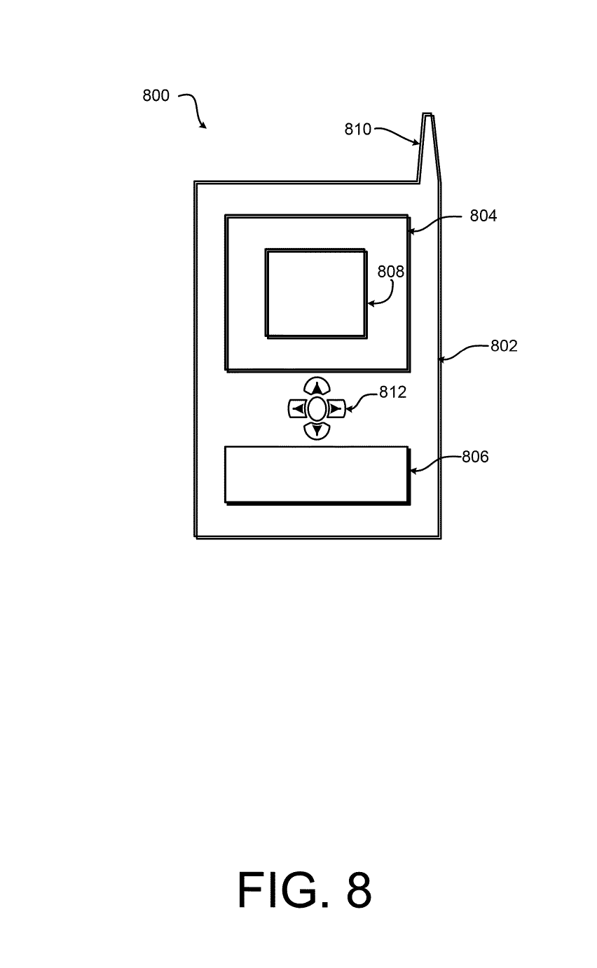

As shown in FIG. 8, device 800 may include a housing 802, a display screen 804, an input/output (I/O) device 806, a network interface card (NIC) 808 and a transceiver component 810. Device 800 also may include navigation features 812. The display screen 804 may include any suitable display unit for displaying information appropriate for a mobile computing device. For example, the display screen 804 displays the personalized message that the personalized communication program may generate. The I/O device 806 may include any suitable I/O device or user interface (UI) for entering information into a mobile computing device such as when the user 102 opts-in to the personalized communication program. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone (not shown). Such information may be digitized by a voice recognition device (not shown). The embodiments are not limited in this context.

The NIC 808 may contain a unique MAC address 206 that specifically identifies the wireless device 106. For example, the wireless device 106 communicates the unique MAC address 206 during data exchange when establishing wireless connection within the PPC zones 212. The transceiver component 810 may implement this establishing of wireless connection. For example, the transceiver component 810 detects the radio signal (e.g., Wi-Fi based WAP 208, Bluetooth™ signal, or cellular signal) when the wireless device 106 enters the PPC zones 212. In this example, the detecting of the radio signal may include establishing of wireless connection by the wireless device 106 to the Wi-Fi based WAP 208. After establishing the wireless connection, the transceiver component 810 may implement the receiving of the personalized message that the personalized communication program may generate.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

1. A method comprising:
identifying a wireless device that is physically located within one or more designated personalized proximity communication (“PPC”) zones;
in a data structure of user datasets, finding a dataset of a user associated with the identified wireless device;
determining whether the found dataset includes an affirmative indication of participation in personalized proximity communication;
in response to a determination that the found dataset includes an affirmative indication of participation, communicating with the user of the identified wireless device, wherein the communicating occurs within the one or more designated PPC zones in which the identified wireless device is located.

2. A method as recited by claim 1, wherein:
the found dataset of the user includes personalized data about the user;
the communicating with the user includes generating a personalized message to the user, the personalized message includes or is based upon the personalized data in the found dataset.

3. A method as recited by claim 2, wherein the communicating further includes:
selecting one or more digital signs that are observable from the one or more designated PPC zones in which the identified wireless device is located;
displaying the personalized message on the one or more selected digital signs.

4. A method as recited by claim 2, wherein the communicating further includes sending the personalized message to the user via the identified wireless device.

5. A method as recited by claim 2, wherein the personalized message is selected from a group consisting of an advertisement, a coupon, a promotion, directions, turn-by-turn navigational instructions, and helpful personalized information.

6. A method as recited by claim 1, wherein the identifying comprises:
determining whether the wireless device is physically located within the one or more designated PPC zones;
in response to the determining that the wireless device is located within the one or more designated PPC zones, wirelessly obtaining a device identifier from the wireless device, wherein the device identifier uniquely identifies the wireless device.

7. The method as recited by claim 1, wherein:
the one or more designated PPC zones include wireless local area networks (“WLANs”);
the identifying comprises:
determining whether the wireless device is physically located within range of the one or more designated WLANs;
in response to the determining that the wireless device is located within range of the one or more designated WLANs, wirelessly obtaining a Media Access Control (“MAC”) address from the wireless device.

8. A method as recited by claim 1, wherein:
the one or more designated PPC zones include wireless personal area networks (“WPANs”);
the identifying comprises:
determining whether the wireless device is physically located within range of the one or more designated WPANs;
in response to the determining that the wireless device is located within range of the one or more designated WPANs, wirelessly obtaining a Media Access Control (“MAC”) address from the wireless device.

9. A method as recited by claim 1, wherein:
the one or more designated PPC zones include Bluetooth personal area networks (“Bluetooth PANs”);
the identifying comprises:
determining whether the wireless device is physically located within range of the one or more designated Bluetooth PANs;
in response to the determining that the wireless device is located within range of the one or more designated Bluetooth PANs, wirelessly obtaining a Media Access Control (“MAC”) address from the wireless device.

10. A method as recited by claim 1, further comprising:
receiving personalized data about the user;
storing the personalized data about the user in association with the found dataset.

11. A method as recited by claim 1, further comprising:
receiving personalized data about the user from the user;
storing the personalized data about the user in association with the found dataset.

12. A method as recited by claim 1, further comprising:
obtaining a device identifier of the wireless device;
storing the device identifier in association with the found dataset.

13. A method as recited by claim 1, further comprising:
receiving an indication of participation in personalized proximity communication for the user, wherein such indication is either affirmative and thus indicates the user's desire to participate and a degree of participation in personalized proximity communication or negative and thus indicates the user's desire to not participate in the personalized proximity communication;
storing the indication of participation in personalized proximity communication in association with the found dataset.

14. A method as recited by claim 1, wherein the wireless device is selected from a group consisting of phone, cell phone, smartphone, tablet computer, personal digital assistant (PDA), portable computer, laptop, netbook, digital camera, and digital media player.

15. One or more processor-readable media having encoded thereon processor-executable instructions that, when executed by one or more processors, direct a performance of operations, the operations comprising:
identifying a wireless device that is physically located within one or more designated personalized proximity communication (“PPC”) zones;
in a data structure of user datasets, finding a dataset of a user associated with the identified wireless device;
determining whether the found dataset includes an indication of degree of participation in personalized proximity communication;
responding accordingly to the determination regarding the indication of degree of participation in personalized proximity communication by either initiating communication with the user of the identified wireless device or abstaining from such communication with the user.

16. One or more processor-readable media as recited by claim 15, wherein the responding operation includes communicating with the user of the identified wireless device in the event that the found dataset includes an affirmative indication of degree of participation, wherein the communicating occurs within the one or more designated PPC zones in which the identified wireless device is located.

17. One or more processor-readable media as recited by claim 16, wherein:
the found dataset of the user includes personalized data about the user;
the communicating with the user includes generating a personalized message to the user, the personalized message includes or is based upon the personalized data in the found dataset.

18. One or more processor-readable media as recited by claim 17, wherein the communicating further includes:
selecting one or more digital signs that are observable from the one or more designated PPC zones in which the identified wireless device is located;
displaying the personalized message on the one or more selected digital signs.

19. One or more processor-readable media as recited by claim 17, wherein the communicating further includes sending the personalized message to the user via the identified wireless device.

20. One or more processor-readable media as recited by claim 15, wherein the identifying comprises:
determining whether the wireless device is physically located within the one or more designated PPC zones;
in response to the determining that the wireless device is located within the one or more designated PPC zones, wirelessly obtaining a device identifier from the wireless device, wherein the device identifier uniquely identifies the wireless device.

21. One or more processor-readable media as recited by claim 15, further comprising:
receiving personalized data about the user from the user;
storing the personalized data about the user in association with the found dataset.

22. One or more processor-readable media as recited by claim 15, further comprising:
obtaining a device identifier of the wireless device;
storing the device identifier in association with the found dataset.

23. One or more processor-readable media as recited by claim 15, further comprising:
receiving the indication of participation in personalized proximity communication for the user;
storing the indication of participation in personalized proximity communication in association with the found dataset.

24. One or more processor-readable media as recited by claim 15, further comprising:
receiving an indication of degree of participation in personalized proximity communication for the user, wherein such indication is either affirmative and thus indicates the user's desire to participate and a degree of participation in personalized proximity communication or negative and thus indicates the user's desire to not participate in the personalized proximity communication;
storing the indication of degree of participation in personalized proximity communication in association with the found dataset.

25. A system that facilitates personalized proximity communication, the system comprising:
a data structure configured to store datasets of users, wherein a dataset includes fields configured to store:
user information that provides identification data for an individual user associated with the dataset;
personalized data that provides data that is personalized and particular to the individual user associated with the dataset;
participation data that provides an indication of degree of participation in personalized proximity communication for the individual user associated with the dataset;
device identification that provides unique identification for a wireless device associated with the user;
a personalized proximity communication (“PPC”) subsystem configured to identify the wireless device when such device is physically located within one or more designated personalized proximity communication (“PPC”) zones; and
a personalized messaging subsystem configured to:
find a dataset of a user associated with the wireless device identified by the PPC subsystem;
determine whether the found dataset includes an affirmative indication of participation in personalized proximity communication;
in response to a determination that the found dataset includes an affirmative indication of participation, generate a personalized message to the user, the personalized message includes or is based upon the personalized data in the found dataset,
the PPC subsystem being further configured to communicate, using the generated personalized message, with the user of the wireless device within the one or more designated PPC zones in which the identified wireless device is located.

26. A system as recited by claim 25, further comprising a dataset update subsystem configured to obtain data to update one or more user datasets.

27. A system as recited by claim 25, further comprising a dataset update subsystem configured to obtain data to update one or more user datasets, wherein updated data includes receiving an indication of participation in personalized proximity communication for the individual user associated with the dataset, wherein such indication is either affirmative and thus indicates the user's desire to participate and a degree of participation in personalized proximity communication or negative and thus indicates the user's desire to not participate in the personalized proximity communication.

28. A method comprising:
receiving of input from a user by a wireless device with regard to opt-in option to create a dataset for the user, wherein the dataset includes an identification of the wireless device;
establishing a wireless connection by the wireless device to a wireless access point (WAP) within one or more designated personalized proximity communication (“PPC”) zones, wherein the establishing includes identifying the wireless device and finding the dataset of the user associated with the identified wireless device;
receiving a response based on the found dataset that includes an affirmative indication of participation by the user, wherein the response includes a communication that occurs within the one or more designated PPC zones in which the identified wireless device is located.

29. The method as recited by claim 28, wherein:
the one or more designated PPC zones include wireless local area networks (“WLANs”) or wireless personal area networks (“WPANs”);
the establishing comprises:
communicating a Media Access Control (“MAC”) address of the wireless device during data exchange within range of the one or more designated WLANs or WPANs.

30. A wireless device comprising:
a user interface (UI) to receive an input from a user with regard to opt-in option to create a dataset for the user;
a network interface card (NIC) to include a media access control (MAC) address identification for the wireless device;
a transceiver component to perform detecting of a radio signal within one or more designated personalized proximity communication (“PPC”) zones, wherein the detecting of the radio signal comprises:
establishing of wireless connection by communicating the MAC address of the wireless device to a wireless access point (WAP) within the one or more designated PPC zones;
receiving a response based from a dataset that corresponds to the communicated MAC address, wherein the response includes a communication that occurs within the one or more designated PPC zones in which the wireless device is located;
a screen to display the response.
